(19) United States
(12) Patent Application Publication
(10) Pub. No.: US 2006/0162529 A1
(43) Pub. Date: Jul. 27, 2006

(54) Collapsible and adjustable stand for a musical instrument

(76) Inventor: Wu-Hong Hsieh, Lu Chou City (TW)

Correspondence Address: POSZ LAW GROUP, PLC, 12040 SOUTH LAKES DR., SUITE 101, RESTON, VA, 20191, US

(21) Appl. No.: 11/043,154

(22) Filed: Jan. 27, 2005

(51) Int. Cl. G10G 5/00; G10D 3/00

(52) U.S. Cl. 84/327

(57) ABSTRACT

A collapsible and adjustable stand for a musical instrument has a rod and a holder. The rod has an upper seat pivotally mounted on a top end thereof, a V-like head provided on the upper seat, a slot defined in a middle portion thereof, a lower seat slidably provided in the slot, a bracket mounted on the lower seat, a channel defined at a lower end thereof and a pin slidably received in the channel. The holder has a first end pivotally provided on the lower end of the rod, a notch defined in the first end for positioning the pin in the notch in the unfolded status, a first leg pivotally mounted on a second end of the holder, two joints provided on two lateral sides of the holder and each having a second foot pivotally mounted on the joint.

### BACKGROUND OF THE INVENTION

1. Field of the Invention

The present invention relates to a collapsible and adjustable stand for a musical instrument, and more particularly to a stand which can be folded for storage and can be adjusted in height for accommodating a variety of musical instruments of different sizes such as a saxophone and a guitar.

2. Description of Related Art

With reference to FIG. 6, a stand for a saxophone comprises a rod (60), a V-like head (61) on a top end of the rod (60), an arcuate bracket (62) provided under the V-like head (61), a holder (63) on a lower end of the rod (60) and multiple legs (64) laterally extending outwards from the holder (63). The legs (64) can be folded downwardly to become parallel to the rod (60).

With reference to FIG. 7, a stand for a guitar comprises a rod (70), a V-like head (71) on a top end of the rod (70), a T-like bracket (72) provided under the V-like head (71), a holder (73) on a lower end of the rod (70) and multiple shafts (74) laterally extending outwards from the holder (73). The configurations of the stand for the saxophone and that for the guitar are similar except that the rod (60) of the former is shorter than that of the latter. Furthermore, the arcuate bracket (62) is used to support a lower end of the saxophone and the T-like bracket (72) is used to support a main body of the guitar.

In use, the arcuate bracket (62) and T-like bracket (72) are respectively and immovably provided on the rods (60, 70) so that the heights of the rods (60, 70) can not be adjusted. Furthermore, although the legs (64, 74) can be folded downwardly, the stand for the saxophone or the stand for the guitar still occupies too much space in storage.

Therefore, the invention provides a collapsible and adjustable stand for a musical instrument to mitigate or obviate the aforementioned problems.

### SUMMARY OF THE INVENTION

The main objective of the present invention is to provide a collapsible and adjustable stand for a musical instrument of which a bracket can be adjusted in height to support a variety of musical instruments of different sizes such as a saxophone, a guitar etc.

A further objective of the present invention is to provide the collapsible and adjustable stand for the musical instrument, wherein legs can be folded upwardly thereby reducing storage space required.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a collapsible and adjustable stand for a musical instrument in accordance with the present invention and being in an unfolded status;

FIG. 2 is a perspective view of the collapsible and adjustable stand for a musical instrument in accordance with the present invention and in a folded status;

FIG. 3 is a schematic view showing a folding procedure of the collapsible and adjustable stand for a musical instrument in accordance with the present invention;

FIG. 4 is a perspective view of the collapsible and adjustable stand for a musical instrument in accordance with the present invention supporting a saxophone;

FIG. 5 is a perspective view of the collapsible and adjustable stand for a musical instrument in accordance with the present invention supporting a guitar;

FIG. 6 is a perspective view of a conventional stand for supporting the guitar; and

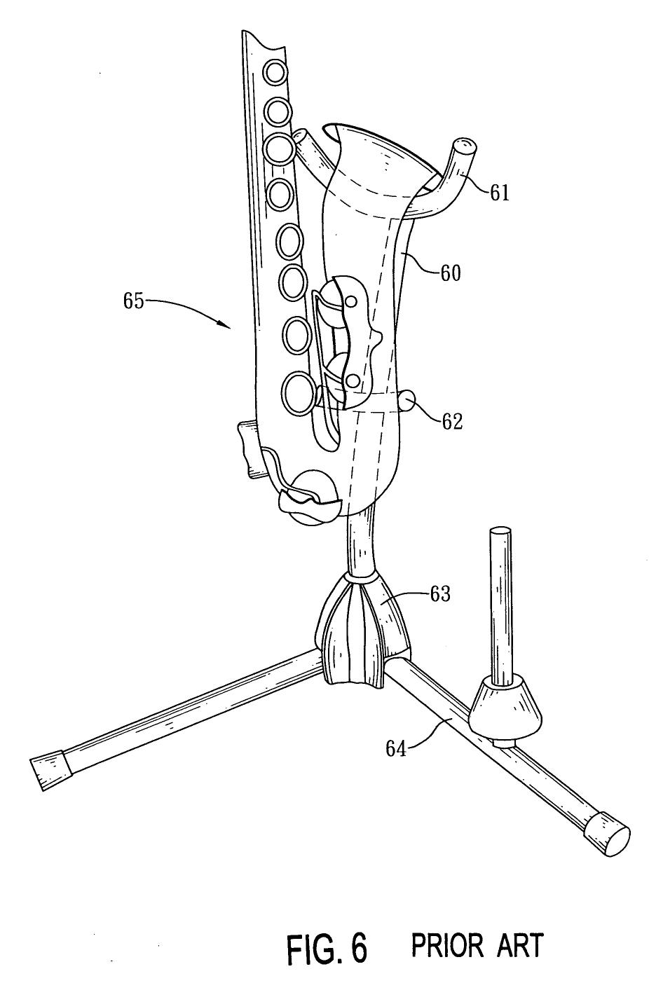

FIG. 7 is a perspective view of another conventional stand for supporting a saxophone.

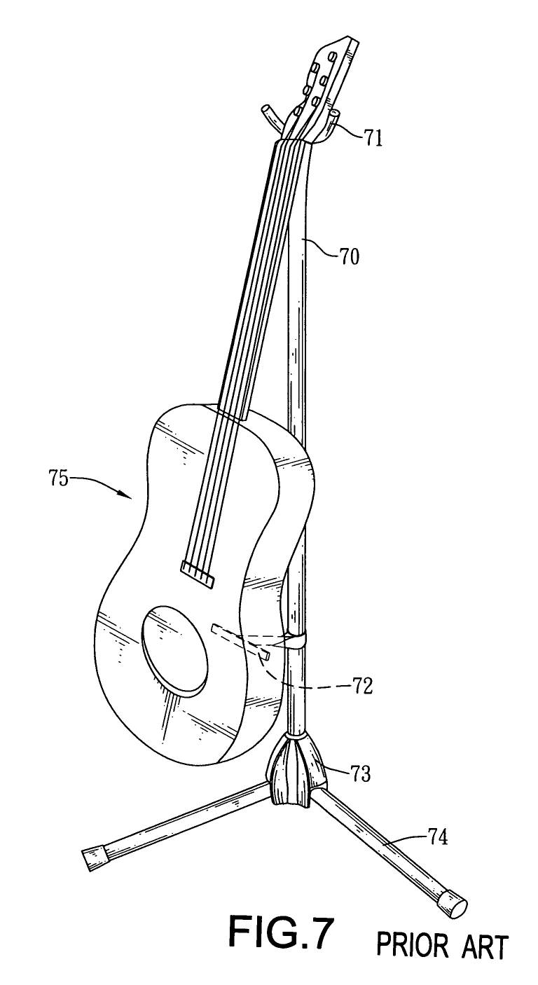

### DETAILED DESCRIPTION OF THE PREFERRED EMBODIMENT

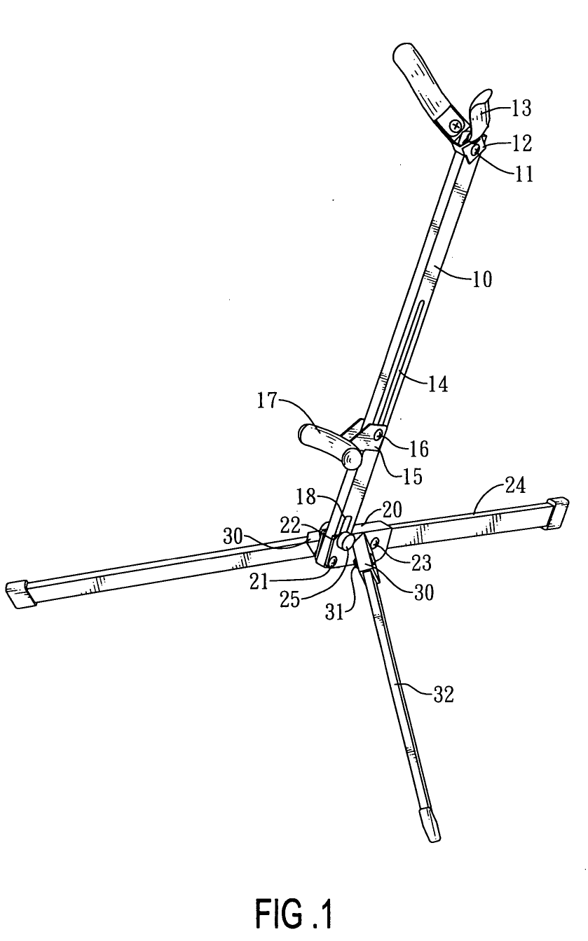

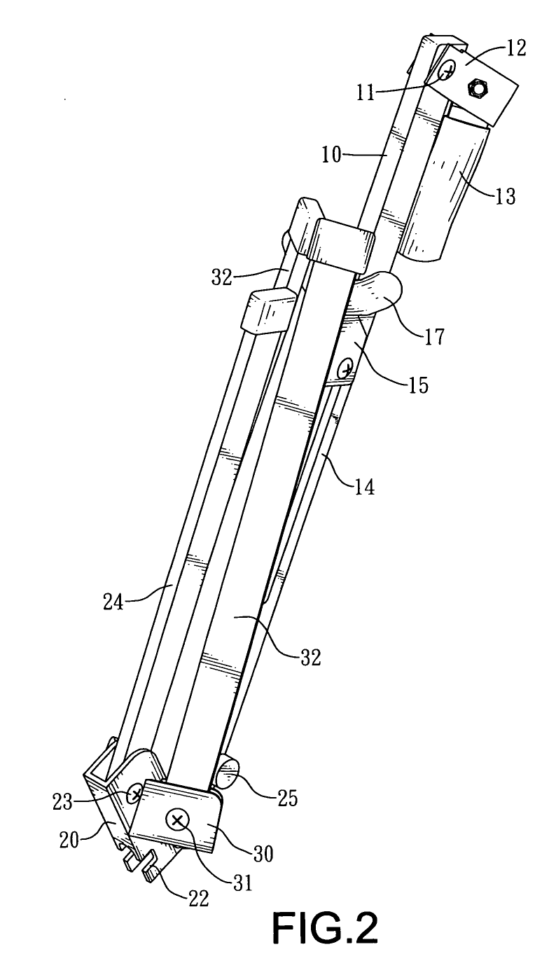

With reference to FIGS. 1-3, a collapsible and adjustable stand for a musical instrument comprises a rod (10) and a holder (20). An upper seat (12) is pivotally provided on a top end of the rod (10) with a first fastener (11). A V-like head (13) is provided on the upper seat (12) thereby supporting a top end of the musical instrument. A slot (14) is defined in a middle portion of the rod (10) and a lower seat (15) is provided on the rod (10). As a result, the lower seat (15) can slide along the slot (14) and be positioned in the slot (14) via a second fastener (16) which is inserted into the slot (14) and the lower seat (15). A bracket (17) is mounted on the lower seat (15). A channel (18) is defined in a lower end of the rod (10) and a pin (25) is slidably mounted in the channel (18).

The holder (20) has a first end pivotally mounted on the lower end of the rod (10) by a first pivot pin (21), and a first leg (24) pivotally mounted at a second end thereof by a second pivot pin (23). Two joints (30) are pivotally mounted on two lateral sides of the holder (20). Two second feet (32) are respectively and pivotally mounted on the joints (30) by a third pivot pin (31). A notch (22) is defined at a top end of the holder (20) so that the pin (25) can be positioned in the notch (22) when the first and the second legs (24, 32) are unfolded.

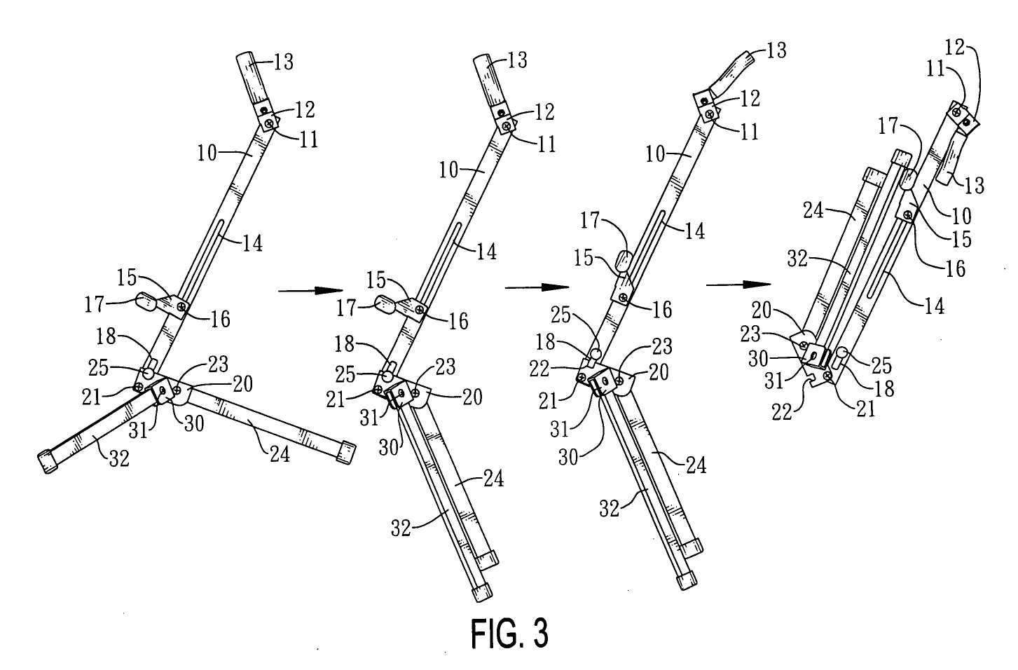

With reference to FIG. 3, in a folding procedure, the first and the second legs (24, 32) are pivoted and put together. Then the holder (20) is pivoted upwardly about the first pivot pin (21) so that the first and the second legs (24, 32) are abutted against the rod (10). Furthermore, the lower seat (15) is pivoted upwards by loosening the second fastener (16) whereby the bracket (17) abuts the rod (10). The upper seat (12) is pivoted upwards by loosening the abutment of the first fastener (11) to the V-like head (13) against the rod (10). Therefore, the collapsible and adjustable stand for the musical instrument has a compact size for storage.

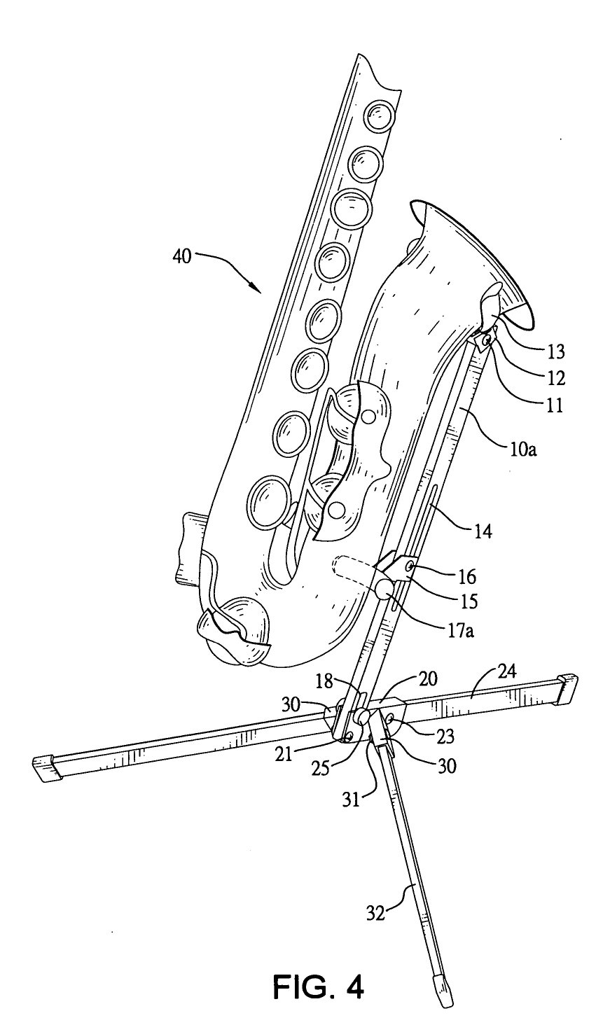

With reference to FIG. 4, for supporting a saxophone, the rod (10a) of the stand in accordance with the invention is short to correspond to the length of the saxophone and the bracket (17a) is formed with an arcuate shape to support an arcuate body of the saxophone and a top end of the saxophone is leaned against the V-like head (13) so that the saxophone can be steadily supported on the collapsible and adjustable stand for a musical instrument. With adjustment of the height of the lower seat (15) by loosening the second fastener (16), the height of the bracket (17a) can be adjusted so that saxophones with a variety of styles can be supported on the collapsible and adjustable stand.

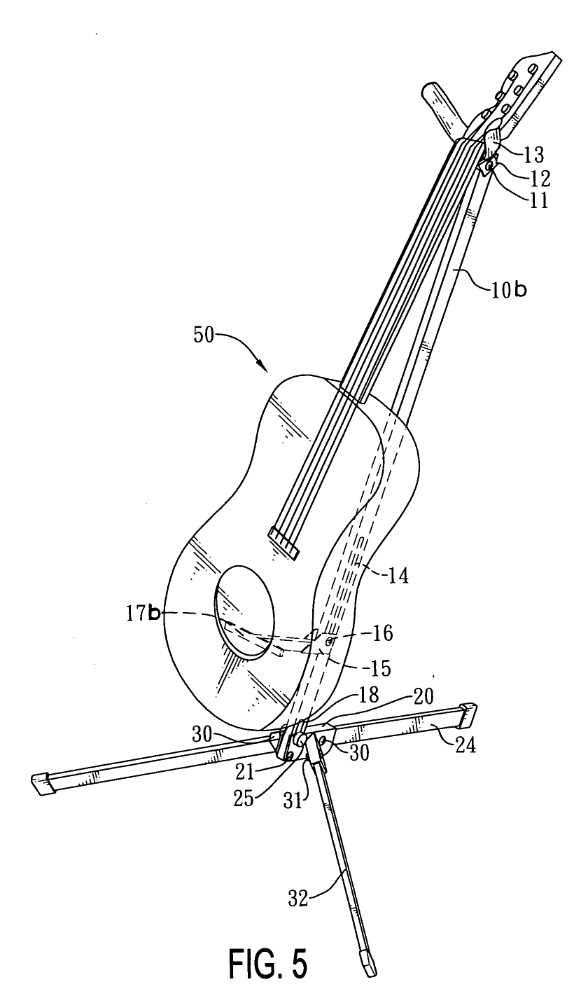

With reference to FIG. 5, for supporting a guitar, the rod (10b) of the stand is of sufficient length to correspond to that of the guitar and the bracket (17b) has a T-like shape for supporting a flat body of the guitar. A top end of the guitar is leaned against the V-like head so that the guitar can be steadily supported on the collapsible and adjustable stand for a musical instrument. With adjustment of the height of the lower seat (15) by loosening the second fastener (16), the height of the bracket (17b) can be adjusted so that guitars with a variety of styles can be supported on the collapsible and adjustable stand.

Additionally, the first fastener (11), the first, second and third pivot pins (21, 23, 32) can be rivets or bolts with nuts, and the second fastener (16) can be replaced with a bolt with a nut.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A collapsible and adjustable stand for a musical instrument comprising:
a rod (10) having an upper seat (12) pivotally mounted on a top end of the rod, a V-like head (13) provided on the upper seat (12), a slot (14) defined in a middle portion of the rod (10), a lower seat (15) slidably provided in the slot (14), a bracket (17) mounted on the lower seat (15), a channel (18) defined in a lower end of the rod (10) and a pin (25) slidably inserted in the channel (18); and
a holder (20), having a first end pivotally provided on the lower end of the rod (10) a notch (22) defined in the first end for positioning the pin (25) in the notch (22) in the unfolded status, a first leg (24) pivotally mounted on a second end of the holder (20), two joints (30) provided on two lateral sides of the holder (20) and each having a second foot (32) pivotally mounted on the joint (30).

2. The collapsible and adjustable stand for a musical instrument as claimed as claim 1, wherein the bracket (17a) is formed with an arcuate shape.

3. The collapsible and adjustable stand for the musical instrument as claimed as claim 1, wherein the bracket (17b) has a T-like shape.
